(19) United States
(12) Patent Application Publication
(10) Pub. No.: US 2026/0073922 A1
(43) Pub. Date: Mar. 12, 2026

(54) AUDIO DIFFUSION WITH LARGE LANGUAGE MODELS

(71) Applicant: Google LLC, Mountain View, CA (US)

(72) Inventors: Yinghui Huang, Forest Hills, NY (US); Kartik Audhkhasi, Mount Kisco, NY (US); Andrew M. Rosenberg, Brooklyn, NY (US); Kyle Scott Kastner, Waltham, MA (US); Bhuvana Ramabhadran, Mt. Kisco, NY (US)

(73) Assignee: Google LLC, Mountain View, CA (US)

(21) Appl. No.: 19/320,199

(22) Filed: Sep. 5, 2025

Related U.S. Application Data
(60) Provisional application No. 63/692,249, filed on Sep. 9, 2024.

(51) Int. Cl. G10L 15/26; G10L 15/06; G10L 15/16

(52) U.S. Cl. CPC G10L 15/26; G10L 15/063; G10L 15/16

(57) ABSTRACT

A method for improving automatic speech recognition (ASR) includes receiving a sequence of original input audio features characterizing a spoken utterance and encoding, using an audio encoder of a speech recognition model, the original input audio features into a sequence of original audio encodings. A sequence processing neural network, such as a large language model, processes the original audio encodings to generate a sequence of text embeddings. A diffusion model, conditioned on the text embeddings, determines an audio correction parameter. The method also includes modifying the original input audio features based on the audio correction parameter to generate a sequence of modified input audio features. The speech recognition model then processes the modified input audio features to generate a final transcription of the spoken utterance.

### CROSS REFERENCE TO RELATED APPLICATIONS

This U.S. Patent Application claims priority under 35 U.S.C. § 119(e) to U.S. Provisional Application 63/692,249, filed on Sep. 9, 2024. The disclosure of this prior application is considered part of the disclosure of this application and is hereby incorporated by reference in its entirety

### TECHNICAL FIELD

This disclosure relates to audio diffusion with large language models.

### BACKGROUND

Automatic speech recognition (ASR) systems are widely used to convert spoken language into written text. These systems typically function by receiving an audio signal containing a spoken utterance, extracting a sequence of acoustic features from the audio signal, and processing these features through a trained model to produce a corresponding text transcription. The accuracy of this transcription is a primary metric for evaluating the performance of an ASR system.

The performance of ASR systems can be affected by various factors. For instance, background noise, speaker accents, or variations in recording quality can introduce artifacts into the input audio signal, leading to errors in the final transcription. Furthermore, utterances that contain out-of-domain terms, such as uncommon proper nouns or specialized jargon, may be misrecognized by ASR models that have not been trained on a sufficient quantity of similar examples

### SUMMARY

One aspect of the disclosure provides a computer-implemented method executing on data processing hardware that causes the data processing hardware to perform operations that include receiving a sequence of original input audio features characterizing a spoken utterance; encoding, by an audio encoder of a speech recognition model, the sequence of original input audio features into a corresponding sequence of original audio encodings; processing, using a sequence processing neural network, the sequence of original audio encodings to generate a sequence of text embeddings; determining, using a diffusion model conditioned on the sequence of text embeddings, an audio correction parameter; modifying the sequence of original input audio features based on the audio correction parameter to generate a sequence of modified input audio features; and processing, using the speech recognition model, the sequence of modified input audio features to generate a final transcription of the spoken utterance.

Implementations of the disclosure may include one or more of the following optional features. In some implementations, when determining the audio correction parameter, the diffusion model is further conditioned on the sequence of original audio encodings. In some examples, the operations also include decoding, by a speech decoder of the speech recognition model, the sequence of original audio encodings to generate, as output from the speech recognition model, an initial transcription of the spoken utterance. Here, when determining the audio correction parameter, the diffusion model is further conditioned on the initial transcription of the spoken utterance. In these examples, the speech decoder may include a recurrent neural network-transducer (RNN-T) architecture or a large language model (LLM)-based decoder. The diffusion model may be further conditioned on the sequence of original input audio features.

The sequence processing neural network may include a large language model (LLM) and the sequence of text embeddings corresponds to an LLM-based transcription of the spoken utterance. Here, modifying the sequence of original input audio features based on the audio correction parameter includes modifying the sequence of original input audio features by applying the audio correction parameter to modify a sub-sequence of the original input audio features. For instance, the sub-sequence of the original input audio features may characterize at least one of a named-entity or a frequently misrecognized term identified in the LLM-based transcription. The audio encoder of the speech recognition model comprises a plurality of multi-head attention layers such as Conformer layers or Transformer layers.

In some implementations, a training process trains the diffusion model to learn how to determine audio correction parameters by: receiving a plurality of training samples each including a corresponding sequence of original training input audio features characterizing a corresponding training utterance and a corresponding ground-truth transcription of the corresponding training utterance; and for each corresponding training sample of the plurality of training samples: encoding, by the audio encoder of the speech recognition model, the sequence of original training input audio features into a corresponding sequence of training audio encodings; decoding, by a speech decoder of the speech recognition model, the corresponding sequence of training audio encodings to generate, as output from the speech recognition model, a corresponding first pass training transcription of the corresponding training utterance; determining a corresponding speech recognition loss based on the corresponding first pass training transcription of the corresponding training utterance and the corresponding ground-truth transcription of the corresponding training utterance; backpropagating the corresponding speech recognition loss through the speech recognition model to determine a corresponding gradient for the speech recognition model; and training the diffusion model to learn how to predict a corresponding audio correction parameter for the corresponding training sample that minimizes the corresponding gradient for the speech recognition model. In these examples, the training process may further train the diffusion model to learn how to determine the audio correction parameters by, for each corresponding training sample of the plurality of training samples: processing, using the sequence processing neural network, the corresponding sequence of training audio encodings to generate a corresponding sequence of training text embeddings, the corresponding sequence of training text embeddings corresponding to a training LLM-based transcription of the corresponding training utterance, wherein, when training the diffusion model to learn how to predict the corresponding audio correction parameter, the diffusion model is conditioned on the corresponding sequence of training text embeddings.

The training process may further train the diffusion model to learn how to determine the audio correction parameters by, for each corresponding training sample of the plurality of training samples: determining a corresponding LLM loss based on the corresponding ground-truth transcription of the corresponding training utterance and the corresponding sequence of training text embeddings, wherein training the diffusion model to learn how to predict the corresponding audio correction parameter includes jointly training the sequence processing neural network based on the corresponding LLM loss and the diffusion model to learn how to predict the corresponding correction parameter for the corresponding training sample that minimizes the corresponding gradient for the speech recognition model.

In some examples, the operations further include, for each corresponding training sample of the plurality of training samples: identifying error patterns in the corresponding LLM-based training transcription based on the corresponding ground-truth transcription of the corresponding training utterance, wherein training the diffusion model to learn how to predict the corresponding audio correction parameter that minimizes the corresponding gradient for the speech recognition model is further based on the identified error patterns. Additionally or alternatively, prior to the training process training the diffusion model, the speech recognition model and the sequence processing neural network may be initially trained on a fine-tuning training set to teach the audio encoder of the speech recognition model to learn how to generate training audio encodings that improve accuracy of training text embeddings generated as output from the sequence processing neural network.

In some implementations, when training the diffusion model to learn how to predict the corresponding audio correction parameter, the diffusion model is conditioned on at least one of the corresponding sequence of original training input audio features, the corresponding sequence of training audio encodings, or the corresponding first pass training transcription. When the training process trains diffusion model, parameters of the speech recognition model may be held fixed.

Another aspect of the disclosure provides a system that includes data processing hardware and memory hardware in communication with the data processing hardware. The memory hardware stores instructions that when executed on the data processing hardware causes the data processing hardware to perform operations that include receiving a sequence of original input audio features characterizing a spoken utterance; encoding, by an audio encoder of a speech recognition model, the sequence of original input audio features into a corresponding sequence of original audio encodings; processing, using a sequence processing neural network, the sequence of original audio encodings to generate a sequence of text embeddings; determining, using a diffusion model conditioned on the sequence of text embeddings, an audio correction parameter; modifying the sequence of original input audio features based on the audio correction parameter to generate a sequence of modified input audio features; and processing, using the speech recognition model, the sequence of modified input audio features to generate a final transcription of the spoken utterance.

Implementations of the disclosure may include one or more of the following optional features. In some implementations, the operations further include when determining the audio correction parameter, the diffusion model is further conditioned on the sequence of original audio encodings. In some examples, the operations also include decoding, by a speech decoder of the speech recognition model, the sequence of original audio encodings to generate, as output from the speech recognition model, an initial transcription of the spoken utterance. Here, when determining the audio correction parameter, the diffusion model is further conditioned on the initial transcription of the spoken utterance. In these examples, the speech decoder may include a recurrent neural network-transducer (RNN-T) architecture or a large language model (LLM)-based decoder. The diffusion model may be further conditioned on the sequence of original input audio features.

The sequence processing neural network may include a large language model (LLM) and the sequence of text embeddings corresponds to an LLM-based transcription of the spoken utterance. Here, modifying the sequence of original input audio features based on the audio correction parameter includes modifying the sequence of original input audio features by applying the audio correction parameter to modify a sub-sequence of the original input audio features. For instance, the sub-sequence of the original input audio features may characterize at least one of a named-entity or a frequently misrecognized term identified in the LLM-based transcription. The audio encoder of the speech recognition model comprises a plurality of multi-head attention layers such as Conformer layers or Transformer layers.

In some implementations, a training process trains the diffusion model to learn how to determine audio correction parameters by: receiving a plurality of training samples each including a corresponding sequence of original training input audio features characterizing a corresponding training utterance and a corresponding ground-truth transcription of the corresponding training utterance; and for each corresponding training sample of the plurality of training samples: encoding, by the audio encoder of the speech recognition model, the sequence of original training input audio features into a corresponding sequence of training audio encodings; decoding, by a speech decoder of the speech recognition model, the corresponding sequence of training audio encodings to generate, as output from the speech recognition model, a corresponding first pass training transcription of the corresponding training utterance; determining a corresponding speech recognition loss based on the corresponding first pass training transcription of the corresponding training utterance and the corresponding ground-truth transcription of the corresponding training utterance; backpropagating the corresponding speech recognition loss through the speech recognition model to determine a corresponding gradient for the speech recognition model; and training the diffusion model to learn how to predict a corresponding audio correction parameter for the corresponding training sample that minimizes the corresponding gradient for the speech recognition model. In these examples, the training process may further train the diffusion model to learn how to determine the audio correction parameters by, for each corresponding training sample of the plurality of training samples: processing, using the sequence processing neural network, the corresponding sequence of training audio encodings to generate a corresponding sequence of training text embeddings, the corresponding sequence of training text embeddings corresponding to a training LLM-based transcription of the corresponding training utterance, wherein, when training the diffusion model to learn how to predict the corresponding audio correction parameter, the diffusion model is conditioned on the corresponding sequence of training text embeddings.

The training process may further train the diffusion model to learn how to determine the audio correction parameters by, for each corresponding training sample of the plurality of training samples: determining a corresponding LLM loss based on the corresponding ground-truth transcription of the corresponding training utterance and the corresponding sequence of training text embeddings, wherein training the diffusion model to learn how to predict the corresponding audio correction parameter includes jointly training the sequence processing neural network based on the corresponding LLM loss and the diffusion model to learn how to predict the corresponding correction parameter for the corresponding training sample that minimizes the corresponding gradient for the speech recognition model.

In some examples, the operations further include, for each corresponding training sample of the plurality of training samples: identifying error patterns in the corresponding LLM-based training transcription based on the corresponding ground-truth transcription of the corresponding training utterance, wherein training the diffusion model to learn how to predict the corresponding audio correction parameter that minimizes the corresponding gradient for the speech recognition model is further based on the identified error patterns. Additionally or alternatively, prior to the training process training the diffusion model, the speech recognition model and the sequence processing neural network may be initially trained on a fine-tuning training set to teach the audio encoder of the speech recognition model to learn how to generate training audio encodings that improve accuracy of training text embeddings generated as output from the sequence processing neural network.

In some implementations, when training the diffusion model to learn how to predict the corresponding audio correction parameter, the diffusion model is conditioned on at least one of the corresponding sequence of original training input audio features, the corresponding sequence of training audio encodings, or the corresponding first pass training transcription. When the training process trains diffusion model, parameters of the speech recognition model may be held fixed.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech model including a diffusion model for improving speech recognition accuracy.

FIG. 2 is schematic view of a training process for training the diffusion model of FIG. 1.

FIG. 3 is a flowchart of an example set of operations for a method of using a diffusion model to improve speech recognition accuracy.

FIG. 4 is a schematic view of an example computing device that may be used to implement the systems and methods described herein.

Like reference symbols in the various drawings indicate like elements.

### DETAILED DESCRIPTION

Automatic speech recognition (ASR) systems are widely used to convert spoken language into written text. These systems typically function by receiving an audio signal containing a spoken utterance, extracting a sequence of acoustic features from the audio signal, and processing these features through a trained model to produce a corresponding text transcription. The accuracy of this transcription is a primary metric for evaluating the performance of an ASR system.

The performance of ASR systems can be affected by various factors. For instance, background noise, speaker accents, or variations in recording quality can introduce artifacts into the input audio signal, leading to errors in the final transcription. Furthermore, utterances that contain out-of-domain terms, such as uncommon proper nouns or specialized jargon, may be misrecognized by ASR models that have not been trained on a sufficient quantity of similar examples.

To address these challenges, some existing approaches utilize multi-pass decoding strategies. A first-pass transcription is generated and then rescored or refined in a subsequent pass. One such approach involves using large language models (LLMs) to rescore or rewrite the initial transcription. In these systems, the LLM processes the text output from the ASR model, using its semantic knowledge to correct potential errors. However, this type of correction is performed on the text domain after the acoustic processing is complete. The LLM does not have direct influence over the underlying acoustic-to-text mapping performed by the ASR model itself. The correction process is dissociated from the initial feature extraction and acoustic modeling stages.

Other approaches focus on enhancing the input audio signal before it is processed by the ASR model. These techniques, often referred to as speech enhancement or denoising, attempt to remove noise or otherwise clean up the audio signal. While these methods can improve robustness to environmental noise, they typically operate without knowledge of the specific ASR model being used or the semantic content of the utterance. As a result, the audio processing is not guided by the potential downstream recognition errors and may not specifically address the acoustic ambiguities that lead to transcription mistakes.

Implementations herein are directed toward predictively modifying input audio features before a final transcription is generated to improve accuracy of a speech recognition model, particular for noisy audio or for audio characterizing out-of-domain terms. Specifically, implementations are directed toward receiving a sequence of original input audio features that characterize a spoken utterance. An audio encoder of the speech recognition model encodes these original input audio features into a sequence of original audio encodings. A sequence processing neural network, such as a large language model (LLM), then processes the sequence of original audio encodings to generate a sequence of LLM output features. Based on these LLM output features, a diffusion model determines an audio correction parameter. The original input audio features are then modified using this audio correction parameter to generate a sequence of modified input audio features. Finally, the speech recognition model processes the sequence of modified input audio features to generate a final transcription of the spoken utterance. This process allows for the integration of semantic context from the LLM to refine the acoustic data itself, potentially correcting errors before a final decoding stage performed by the speech recognition model.

The diffusion model may be conditioned on additional information, such as the original audio encodings or an initial transcription generated by the speech recognition model from the original input audio features. The sequence of LLM output features may include text embeddings corresponding to an LLM-based transcription. Aspects of the present disclosure may include modifying the original input audio features in a targeted manner, for example, by modifying the original input audio features to target specific sub-sequences that correspond to named entities or other terms frequently misrecognized by the speech recognition model.

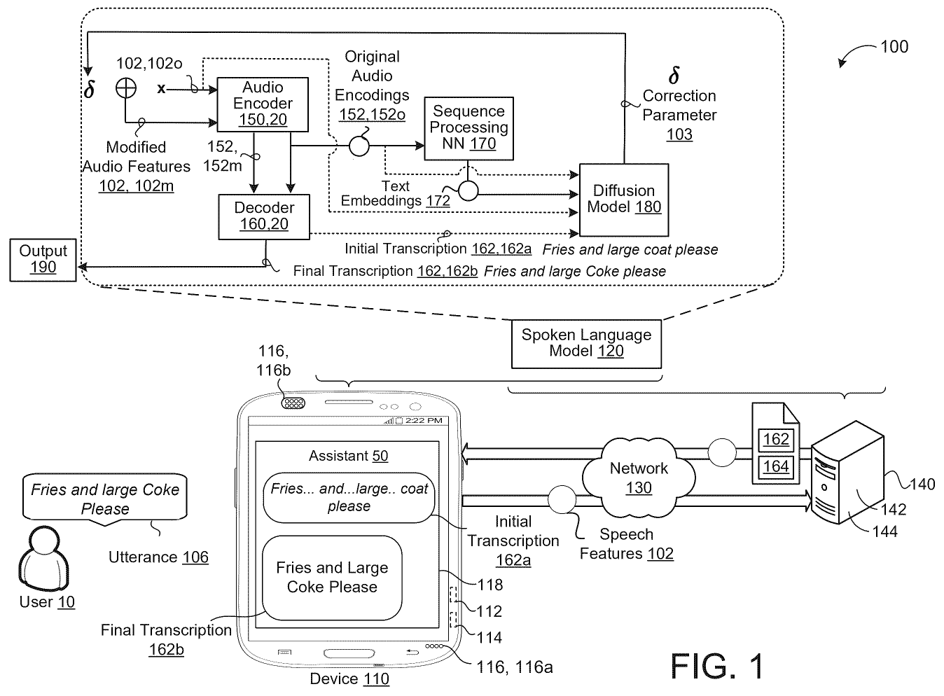

FIG. 1 illustrates an example system 100 whereby a user 10 may interact with a computing device, such as a user device 110, through voice input. The user device 110 (also referred to generally as a device 110) is configured to capture sounds (e.g., streaming audio data) from one or more users 10. Here, the streaming audio data may refer to an utterance 106 spoken by the user 10 that functions as an audible prompt/query, a command for the user device 110, or an audible communication captured by the user device 110. Speech-enabled systems of the user device 110 may field the query or command by answering the query and/or causing the command to be performed/fulfilled by one or more downstream applications (i.e., output 190). For instance, in the example shown, the user 10 interacts with a digital assistant 50 of the user device 110 that uses a spoken language model 120. The digital assistant 50 corresponds to a digital assistant application that displays a graphical user interface 118 on a screen of the user device 110 to depict a conversation between the user 10 and the digital assistant 50.

The user device 110 may correspond to any computing device associated with the user 10 and capable of receiving audio data. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, cause the data processing hardware 112 to perform one or more operations. The user device 110 further includes an audio system 116 with an audio capture device (e.g., microphone) 116, 116a for capturing and converting the utterances 106 spoken by the user 10 into electrical signals and a speech output device (e.g., speaker) 116, 116b for communicating an audible audio signal (e.g., as output audio data from the user device 110). That is, the audio capture device 116a may convert the utterances 106 spoken by the user 10 into a sequence of speech features 102. While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

The user device 110 may communicate with a remote system 140 via a network 130. The remote system 140 may be a distributed system (e.g., cloud computing environment) having scalable elastic resources. The resources include computing resources (e.g., data processing hardware) 142 and/or storage resources (e.g., memory hardware) 144. Additionally or alternatively, the remote system 104 may be a centralized system. The network 130 may be wired, wireless, or a combination thereof, and may include private networks and/or public networks, such as the Internet.

The spoken language model 120 may execute on the user device 110, the remote system 140, or some combination thereof. The spoken language model 120 is configured to receive a respective utterance 106 spoken by the user 10 and generate a transcription 162 of the respective utterance 106. In some examples, the utterances 106 spoken by the user 10 correspond to spoken prompts. As such, utterances 106 may be interchangeably referred to as “spoken prompts 106” herein. Spoken prompts 106 may include any query, command, or other audible communication captured by the user device 110 (e.g., any command or query spoken by the user 10). An output 190 may receive the transcription 162. In some examples, the output interface 190 includes or interfaces with the assistant application 50 to process the transcription 162 and generate a response 164 to the spoken prompt 106. The assistant application 20 may provide the response 164 for output from the user device 110 via the graphical user interface 118. For instance, the graphical user interface 118 may graphically display the response 164 on the screen of the user device 110 and/or audibly output the response 164 as synthesized speech through the speech output device 116b.

The spoken language model 120 may include a speech recognition model 20, a sequence processing neural network 170, and a diffusion model 180. The speech recognition model 20 includes an audio encoder 150 and a speech decoder 160. The audio encoder 150 may be pre-trained and include a plurality of multi-head attention layers such as Conformer layers or Transformer layers. In some examples, the audio encoder 150 includes a cascaded audio encoder that includes a causal encoder and a non-causal encoder stacked on top of the causal encoder. The speech decoder 160 may include a recurrent neural network-transducer (RNN-T) architecture or an LLM-based decoder. The sequence processing neural network 170 may include a large language model (LLM). For simplicity, the present disclosure will refer to the sequence processing neural network 170 as an LLM but the sequence processing neural network 170 may include other types of sequence processing neural networks without departing from the scope of the present disclosure.

The audio encoder 150 of the speech recognition model 20 is configured to receive, as input, a sequence of original input audio features (x) 102, 102o characterizing the spoken utterance 106 and generate, as output, a corresponding sequence of original audio encodings 152, 152o. The sequence of original input audio features 102o may include an input sequence of mel-frequency spectrogram frames. In some examples, the audio encoder 150 operates in a streaming manner. That is, for each respective audio feature 102 in the sequence of original input audio features 102o, the audio encoder 150 generates a corresponding original audio encoding 152o and transmits the corresponding original audio encoding 152o to the speech decoder 160. As such, at each time step (e.g., output step) of a plurality of time steps, the audio encoder 150 generates a corresponding original audio encoding 152o. The audio encoder 150 may additionally or alternatively operate in a non-streaming mode and process look-ahead or right context on the audio features 102o when generating an audio encoding 152 for a corresponding audio feature 102.

The speech decoder 160 of the speech recognition model 20 is configured to receive, as input, the sequence of original audio encodings 152o output from the audio encoder 150 and generate, as output, an initial transcription 162, 162a of the spoken utterance 106. Artifacts resulting from various factors such as background noise, speaker accents, or variations in recording quality can be introduced into the sequence of original input audio features (x) 102, which may lead to errors in the initial transcription 162, 162a output by the speech recognition model 20. Furthermore, utterances that contain out-of-domain terms, such as uncommon proper nouns or specialized jargon, may be misrecognized by the speech recognition model 20 when the speech recognition model 20 has not been trained on a sufficient quantity of similar examples. In the example shown, the utterance 106 spoken by the user 10 includes “Fries and large Coke please”, but the initial transcription 162a generated by the speech recognition model 20 is misrecognized as “Fries and large coat please” in which the speech recognition model 20 misrecognized the term “coat” instead of the correct term “Coke”. In some examples, the assistant application 50 displays the initial transcription 162a in a streaming fashion.

To address these challenges attributed to noisy audio and/or audio containing out-of-domain terms, the spoken language model 120 leverages the LLM 170 and the diffusion model 180 to improve the accuracy of the speech recognition model 20 by predictively modifying the original input audio features 102o based on the original audio encodings 152o. Here, the LLM 170 processes the sequence of original audio encodings 152o output by the audio encoder 150 to generate, as output, a sequence of text embeddings 172. The sequence of text embeddings 172 may correspond to a LLM-based transcription of the spoken utterance. Thereafter, the spoken language model 20 determines, using the diffusion model 180 conditioned on the sequence of text embeddings 172 output from the LLM 170, an audio correction parameter (δ) 103, and modifies the sequence of original input audio features (x) 102o based on the audio correction parameter 103 to generate a sequence of modified input audio features 102, 102m. Finally, the speech recognition model 20 processes the sequence of modified input audio features 102m to generate the final transcription 162b of the spoken utterance 106. That is, during a second-pass, the audio encoder 150 encodes the modified input audio features 102m into a corresponding sequence of modified audio encodings 152, 152m and the speech decoder 160 decodes the modified input audio features 152m to generate, as output, from the speech recognition model 20, the final transcription 162b. In the example shown, the final transcription 162b includes “Fries and large Coke please”, revealing that that the speech recognition model 20 accurately recognized the spoken utterance 162 when using the modified input audio features 102m. The final transcription 162b may be provided to the output 190 which may process the final transcription 162b to generate a response 164 to the spoken utterance 106. In some implementations, the output 190 includes the LLM 170 or a different LLM that processes the natural language final transcription 162b to generate the response 164. Additionally or alternatively, the output 190 may cause the graphical user interface 118 to display the final transcription 162b on the screen of the user device 110. When the initial transcription 162a was displayed, the final transcription 162b may replace the initial transcription 162a.

In some implementations, when determining the correction parameter (δ) 103, the diffusion model 180 is further conditioned on the sequence of original audio encodings 152o corresponding to the sequence of original input audio features 102o encoded by the audio encoder 150. In some additional implementations, when determining the correction parameter 103, the diffusion model 180 is further conditioned on the initial transcription 162a of the spoken utterance 106. In some additional implementations, when determining the correction parameter 103, the diffusion model 180 is further conditioned on the sequence of original input audio features 102o. When determining the correction parameter 103, the diffusion model 180 is conditioned on the sequence of text embeddings 172 and further conditioned on at least one of the sequence of original audio encodings 152, the initial transcription 162a of the spoken utterance 106, or the sequence of original input audio features 102o.

In some examples, the spoken language model 120 modifies the sequence of original input audio features 102 by applying the audio correction parameter (δ) 103 to modify a sub-sequence of the original input audio features that characterizes at least one of a named-entity or a frequently misrecognized term identified in the LLM-based transcription. For instance, in the example shown, the spoken language model 120 may modify the sequence of original input audio features 102o by applying the audio correction parameter 103 to modify a sub-sequence of the original input features 102o that characterizes the term “Coke” identified in the sequence of text embeddings 172 corresponding to the LLM-based transcription of the spoken utterance.

Beyond the example of a digital assistant, the described implementations can be applied to other domains where transcription accuracy is critical. For instance, in the context of transcribing dictated recorded speech, such as medical or legal dictation, the system can significantly improve accuracy for specialized jargon and out-of-domain terminology. A doctor dictating a patient report might use complex medical terms that a standard ASR model could misinterpret; the proposed system could leverage textual embeddings 172 indicating the LLM's contextual understanding to identify the likely correct medical term, guide the diffusion model 180 to modify the audio features, and generate a highly accurate transcription, reducing the need for manual correction. Similarly, this technology can be used to enhance Closed-Captioning for live broadcasts or streaming media. In a live news report or sporting event with significant background noise, an initial caption may contain errors. The system could process the audio in near-real-time, correct for ambient noise and misrecognized proper nouns (e.g., names of athletes or politicians), and replace the initial, erroneous caption with a refined, more accurate final transcription, thereby improving accessibility and the viewer experience.

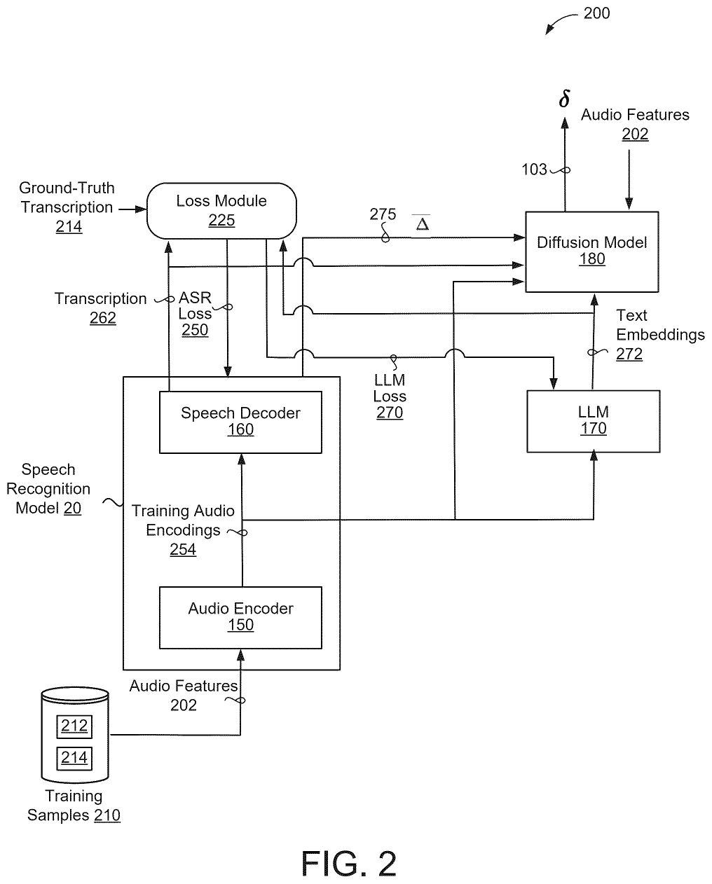

FIG. 2 illustrates an example training process 200 for training the diffusion model 180 (FIG. 1) of the spoken language model 120 (FIG. 1). The training process 200 obtains a plurality of training samples 210 to train the diffusion model 180. Each training sample 210 includes a corresponding sequence of original training input audio features 202 characterizing a corresponding training utterance and a corresponding ground-truth transcription 214 of the corresponding training utterance. For each corresponding training sample 210 of the plurality of training samples, the audio encoder 150 of the speech recognition model 20 encodes the sequence of original training input audio features into a corresponding sequence of training audio encodings 254, and the speech decoder 160 decodes the corresponding sequence of training audio encodings 254 to generate, as output from the speech recognition model, a corresponding first pass training transcription 262 of the corresponding training utterance. The training process 200 further determines, using a loss module 225, a corresponding speech recognition loss 250 based on the corresponding first pass training transcription 262 and the corresponding ground-truth transcription 262 of the corresponding training utterance. The training process 200 backpropagates the corresponding speech recognition loss 250 through the speech recognition model to determine a corresponding gradient (Δ) 275 for the speech recognition model 20. The training process 200 trains the diffusion model 180 to learn how to predict a corresponding audio correction parameter (δ) 103 for the corresponding training sample 210 that minimizes the corresponding gradient 274 for the speech recognition model 20. Specifically, the diffusion model 180 is trained to learn how to predict the corresponding audio correction parameter 103 for the corresponding sequence of original training input audio features 202 that minimizes the corresponding gradient 274.

Prior to the training process 200 training the diffusion model 180, the speech recognition model 20 and the sequence processing neural network 170 may be initially trained on a fine-tuning training set to each the audio encoder 150 of the speech recognition model to learn how to generate training audio encodings 254 that improve accuracy of the training text embeddings 272 generated as output from the sequence processing neural network 170. Parameters of the speech recognition model 20 may be held fixed when the training process 200 trains the diffusion model 20.

In some examples, the training process further trains the diffusion model 180 to learn how to determine the audio correction parameters 103 by, for each corresponding training sample 210, processing, using the sequence processing neural network (e.g., LLM) 170, the corresponding sequence of training audio encodings 254 to generate a corresponding sequence of training text embeddings 272. The training text embeddings 272 may correspond to an LLM-based training transcription of the corresponding training utterance. Here, when training the diffusion model to learn how to predict the corresponding audio correction parameter 103, the diffusion model 180 is conditioned on the corresponding sequence of training text embeddings 272. In some implementations, the diffusion model 180 is conditioned on at least one of the corresponding sequence of original training input audio features 202, the corresponding sequence of training audio encodings 254, or the corresponding first pass training transcription 262.

Optionally, the training process 200 may jointly train the sequence processing neural network 170 and the diffusion model 180. Here, for each corresponding training sample 210 of the plurality of training samples 210, the loss module 225 may further determine a corresponding LLM loss 270 based on the corresponding ground-truth transcription 262 of the corresponding training utterance and the corresponding sequence of training text embeddings 272. The training process 200 then jointly trains the sequence processing neural network 170 based on the corresponding LLM loss 270 and the diffusion model 180 to learn how to predict the corresponding correction parameter 103 for the corresponding training sample that minimizes the corresponding gradient 274 for the speech recognition model 20. In some scenarios, for each corresponding training sample 212, the training process 200 (e.g., via the loss module 225) identifies error patterns in the corresponding LLM-based training transcription based on the corresponding ground-truth transcription of the corresponding training utterance such that training the diffusion model 180 to learn how to predict the corresponding audio correction parameter 103 that minimizes the corresponding gradient 275 for the speech recognition model 20 is further based on the identified error patterns.

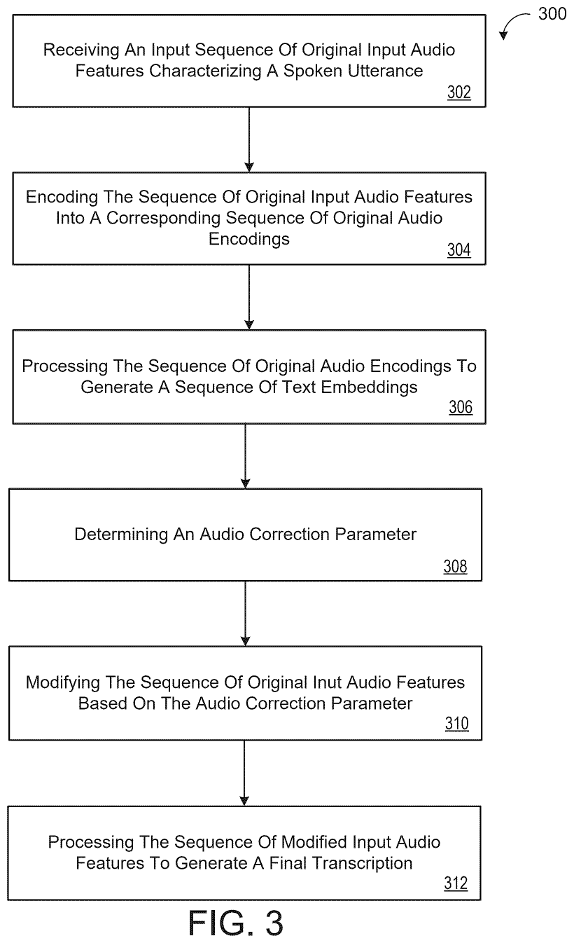

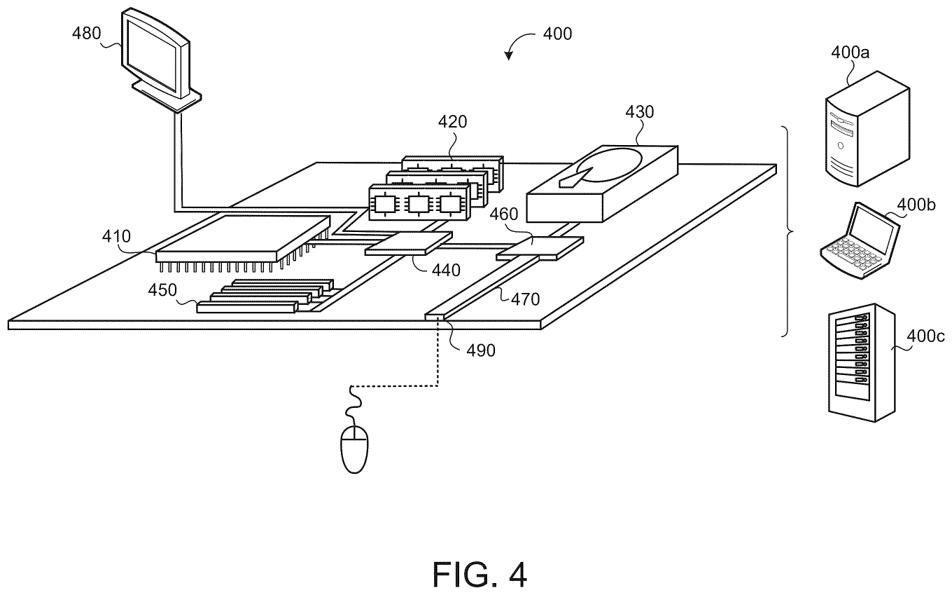

FIG. 3 includes a flowchart of an example arrangement of operations for a computer-implemented 300 of executing a spoken language model. The method 300 may execute on data processing hardware 410 (FIG. 4) using instructions stored on memory hardware 420 (FIG. 4) that may reside on the user device 110 and/or the remote system 140 of FIG. 1 each corresponding to a computing device 400 (FIG. 4).

At operation 402, the method 400 includes a sequence of original input audio features 102 characterizing a spoken utterance 106. At operation 404, the method 400 includes encoding, by an audio encoder 150 of a speech recognition model 20, the sequence of original input audio features 102 into a corresponding sequence of original audio encodings 154. At operation 306, the method includes processing, using a sequence processing neural network 170, the sequence of original audio encodings 102 to generate a sequence of text embeddings 172. At operation 308, the method 300 includes determining, using a diffusion model 170 conditioned on the sequence of text embeddings 172, an audio correction parameter 103. At operation 310, the method 300 includes modifying the sequence of original input audio features 102 based on the audio correction parameter 103 to generate a sequence of modified input audio features 102. At operation 312, the method 300 includes processing, using the speech recognition model 20, the sequence of modified input audio features 102 to generate a final transcription 162 of the spoken utterance 106.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 440, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter, The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a sequence of original input audio features characterizing a spoken utterance;
encoding, by an audio encoder of a speech recognition model, the sequence of original input audio features into a corresponding sequence of original audio encodings;
processing, using a sequence processing neural network, the sequence of original audio encodings to generate a sequence of text embeddings;
determining, using a diffusion model conditioned on the sequence of text embeddings, an audio correction parameter;
modifying the sequence of original input audio features based on the audio correction parameter to generate a sequence of modified input audio features; and
processing, using the speech recognition model, the sequence of modified input audio features to generate a final transcription of the spoken utterance.

2. The computer-implemented method of claim 1, wherein, when determining the audio correction parameter, the diffusion model is further conditioned on the sequence of original audio encodings

3. The computer-implemented method of claim 1, wherein the operations further comprise:
decoding, by a speech decoder of the speech recognition model, the sequence of original audio encodings to generate, as output from the speech recognition model, an initial transcription of the spoken utterance,
wherein, when determining the audio correction parameter, the diffusion model is further conditioned on the initial transcription of the spoken utterance.

4. The computer-implemented method of claim 3, wherein the speech decoder of the speech recognition model comprises a recurrent neural network-transducer (RNN-T) architecture.

5. The computer-implemented method of claim 3, wherein the speech decoder of the speech recognition model comprises a large language model (LLM)-based decoder.

6. The computer-implemented method of claim 1, wherein, when determining the audio correction parameter using the diffusion model, the diffusion model is further conditioned on the sequence of original input audio features.

7. The computer-implemented method of claim 1, wherein the sequence processing neural network comprises a large language model (LLM) and the sequence of text embeddings corresponds to an LLM-based transcription of the spoken utterance.

8. The computer-implemented method of claim 7, wherein modifying the sequence of original input audio features based on the audio correction parameter comprises modifying the sequence of original input audio features by applying the audio correction parameter to modify a sub-sequence of the original input audio features, the sub-sequence of the original input audio features characterizing at least one of a named-entity or a frequently misrecognized term identified in the LLM-based transcription.

9. The computer-implemented method of claim 1, wherein the audio encoder of the speech recognition model comprises a plurality of multi-head attention layers.

10. The computer-implemented method of claim 9, wherein the multi-head attention layers comprise Conformer layers or Transformer layers.

11. The computer-implemented method of claim 1, wherein a training process trains the diffusion model to learn how to determine audio correction parameters by:
receiving a plurality of training samples each comprising:
a corresponding sequence of original training input audio features characterizing a corresponding training utterance; and
a corresponding ground-truth transcription of the corresponding training utterance; and
for each corresponding training sample of the plurality of training samples:
encoding, by the audio encoder of the speech recognition model, the sequence of original training input audio features into a corresponding sequence of training audio encodings;
decoding, by a speech decoder of the speech recognition model, the corresponding sequence of training audio encodings to generate, as output from the speech recognition model, a corresponding first pass training transcription of the corresponding training utterance;
determining a corresponding speech recognition loss based on the corresponding first pass training transcription of the corresponding training utterance and the corresponding ground-truth transcription of the corresponding training utterance;
backpropagating the corresponding speech recognition loss through the speech recognition model to determine a corresponding gradient for the speech recognition model; and
training the diffusion model to learn how to predict a corresponding audio correction parameter for the corresponding training sample that minimizes the corresponding gradient for the speech recognition model.

12. The computer-implemented method of claim 11, wherein the training process further trains the diffusion model to learn how to determine the audio correction parameters by, for each corresponding training sample of the plurality of training samples:
processing, using the sequence processing neural network, the corresponding sequence of training audio encodings to generate a corresponding sequence of training text embeddings, the corresponding sequence of training text embeddings corresponding to a training LLM-based transcription of the corresponding training utterance,
wherein, when training the diffusion model to learn how to predict the corresponding audio correction parameter, the diffusion model is conditioned on the corresponding sequence of training text embeddings.

13. The computer-implemented method of claim 12, wherein the training process further trains the diffusion model to learn how to determine the audio correction parameters by, for each corresponding training sample of the plurality of training samples:
determining a corresponding LLM loss based on the corresponding ground-truth transcription of the corresponding training utterance and the corresponding sequence of training text embeddings,
wherein training the diffusion model to learn how to predict the corresponding audio correction parameter comprises jointly training the sequence processing neural network based on the corresponding LLM loss and the diffusion model to learn how to predict the corresponding correction parameter for the corresponding training sample that minimizes the corresponding gradient for the speech recognition model.

14. The computer-implemented method of claim 13, wherein the operations further comprise, for each corresponding training sample of the plurality of training samples:
identifying error patterns in the corresponding LLM-based training transcription based on the corresponding ground-truth transcription of the corresponding training utterance,
wherein training the diffusion model to learn how to predict the corresponding audio correction parameter that minimizes the corresponding gradient for the speech recognition model is further based on the identified error patterns.

15. The computer-implemented method of claim 12, wherein, prior to the training process training the diffusion model, the speech recognition model and the sequence processing neural network are initially trained on a fine-tuning training set to teach the audio encoder of the speech recognition model to learn how to generate training audio encodings that improve accuracy of training text embeddings generated as output from the sequence processing neural network.

16. The computer-implemented method of claim 11, wherein, when training the diffusion model to learn how to predict the corresponding audio correction parameter, the diffusion model is conditioned on at least one of the corresponding sequence of original training input audio features, the corresponding sequence of training audio encodings, or the corresponding first pass training transcription.

17. The computer-implemented method of claim 11, wherein, when the training process trains diffusion model, parameters of the speech recognition model are held fixed.

18. A system comprising:
data processing hardware; and
memory hardware in communication with the data processing hardware and storing instructions that when executed on the data processing hardware causes the data processing hardware to perform operations comprising:
receiving a sequence of original input audio features characterizing a spoken utterance;
encoding, by an audio encoder of a speech recognition model, the sequence of original input audio features into a corresponding sequence of original audio encodings;
processing, using a sequence processing neural network, the sequence of original audio encodings to generate a sequence of text embeddings;
determining, using a diffusion model conditioned on the sequence of text embeddings, an audio correction parameter,
modifying the sequence of original input audio features based on the audio correction parameter to generate a sequence of modified input audio features; and
processing, using the speech recognition model, the sequence of modified input audio features to generate a final transcription of the spoken utterance.

19. The system of claim 18, wherein, when determining the audio correction parameter, the diffusion model is further conditioned on the sequence of original audio encodings.

20. The system of claim 18, wherein the operations further comprise:
decoding, by a speech decoder of the speech recognition model, the sequence of original audio encodings to generate, as output from the speech recognition model, an initial transcription of the spoken utterance,
wherein, when determining the audio correction parameter, the diffusion model is further conditioned on the initial transcription of the spoken utterance.

21. The system of claim 20, wherein the speech decoder of the speech recognition model comprises a recurrent neural network-transducer (RNN-T) architecture.

22. The system of claim 20, wherein the speech decoder of the speech recognition model comprises a large language model (LLM)-based decoder.

23. The system of claim 18, wherein, when determining the audio correction parameter using the diffusion model, the diffusion model is further conditioned on the sequence of original input audio features.

24. The system of claim 18, wherein the sequence processing neural network comprises a large language model (LLM) and the sequence of text embeddings corresponds to an LLM-based transcription of the spoken utterance.

25. The system of claim 24, wherein modifying the sequence of original input audio features based on the audio correction parameter comprises modifying the sequence of original input audio features by applying the audio correction parameter to modify a sub-sequence of the original input audio features, the sub-sequence of the original input audio features characterizing at least one of a named-entity or a frequently misrecognized term identified in the LLM-based transcription.

26. The system of claim 18, wherein the audio encoder of the speech recognition model comprises a plurality of multi-head attention layers.

27. The system of claim 26, wherein the multi-head attention layers comprise Conformer layers or Transformer layers.

28. The system of claim 18, wherein a training process trains the diffusion model to learn how to determine audio correction parameters by:
receiving a plurality of training samples each comprising:
a corresponding sequence of original training input audio features characterizing a corresponding training utterance; and
a corresponding ground-truth transcription of the corresponding training utterance; and
for each corresponding training sample of the plurality of training samples:
encoding, by the audio encoder of the speech recognition model, the sequence of original training input audio features into a corresponding sequence of training audio encodings;
decoding, by a speech decoder of the speech recognition model, the corresponding sequence of training audio encodings to generate, as output from the speech recognition model, a corresponding first pass training transcription of the corresponding training utterance;
determining a corresponding speech recognition loss based on the corresponding first pass training transcription of the corresponding training utterance and the corresponding ground-truth transcription of the corresponding training utterance;
backpropagating the corresponding speech recognition loss through the speech recognition model to determine a corresponding gradient for the speech recognition model; and
training the diffusion model to learn how to predict a corresponding audio correction parameter for the corresponding training sample that minimizes the corresponding gradient for the speech recognition model.

29. The system of claim 28, wherein the training process further trains the diffusion model to learn how to determine the audio correction parameters by, for each corresponding training sample of the plurality of training samples:
processing, using the sequence processing neural network, the corresponding sequence of training audio encodings to generate a corresponding sequence of training text embeddings, the corresponding sequence of training text embeddings corresponding to a training LLM-based transcription of the corresponding training utterance,
wherein, when training the diffusion model to learn how to predict the corresponding audio correction parameter, the diffusion model is conditioned on the corresponding sequence of training text embeddings.

30. The system of claim 29, wherein the training process further trains the diffusion model to learn how to determine the audio correction parameters by, for each corresponding training sample of the plurality of training samples:
determining a corresponding LLM loss based on the corresponding ground-truth transcription of the corresponding training utterance and the corresponding sequence of training text embeddings,
wherein training the diffusion model to learn how to predict the corresponding audio correction parameter comprises jointly training the sequence processing neural network based on the corresponding LLM loss and the diffusion model to learn how to predict the corresponding correction parameter for the corresponding training sample that minimizes the corresponding gradient for the speech recognition model.

31. The system of claim 30, wherein the operations further comprise, for each corresponding training sample of the plurality of training samples:
identifying error patterns in the corresponding LLM-based training transcription based on the corresponding ground-truth transcription of the corresponding training utterance,
wherein training the diffusion model to learn how to predict the corresponding audio correction parameter that minimizes the corresponding gradient for the speech recognition model is further based on the identified error patterns.

32. The system of claim 29, wherein, prior to the training process training the diffusion model, the speech recognition model and the sequence processing neural network are initially trained on a fine-tuning training set to teach the audio encoder of the speech recognition model to learn how to generate training audio encodings that improve accuracy of training text embeddings generated as output from the sequence processing neural network.

33. The system of claim 28, wherein, when training the diffusion model to learn how to predict the corresponding audio correction parameter, the diffusion model is conditioned on at least one of the corresponding sequence of original training input audio features, the corresponding sequence of training audio encodings, or the corresponding first pass training transcription.

34. The system of claim 28, wherein, when the training process trains diffusion model, parameters of the speech recognition model are held fixed.
